(19) United States
(12) Patent Application Publication
(10) Pub. No.: US 2026/0055341 A1
(43) Pub. Date: Feb. 26, 2026

(54) DEFOAMING COMPOSITIONS FOR DETERGENTS

(71) Applicant: WACKER CHEMIE AG, Munich (DE)

(72) Inventors: Christof BREHM, Burghausen (DE); Andreas Meier, Burgkirchen (DE)

(73) Assignee: Wacker Chemie AG, Munich (DE)

(21) Appl. No.: 18/996,488

(22) PCT Filed: Jul. 20, 2022
(86) PCT No.: PCT/EP2022/070382

§ 371 Date: Jan. 17, 2025

(51) Int. Cl. C11D 3/00; C11D 3/04; C11D 3/10; C11D 3/12; C11D 3/20; C11D 3/37; C11D 11/00

(52) U.S. Cl. CPC C11D 3/0026; C11D 3/046; C11D 3/10; C11D 3/128; C11D 3/2093; C11D 3/3738; C11D 3/3761; C11D 11/0082

(57) ABSTRACT

Described are novel defoamer powders containing (A) 100 parts by weight of a defoamer formulation containing (Aa) a polysiloxane containing units of formula (I): R1R2SiO2/2, in which R1 is a monovalent, optionally branched, SiC-bonded hydrocarbon radical having 1 to 5 carbon atoms, R2 is a monovalent, optionally branched, SiC-bonded hydrocarbon radical having 6 to 30 carbon atoms, (Ab) a filler, (Ac) an organopolysiloxane resin composed of units of the general formula (II): R3a(R4O)bSiO(4-a-b)/2, in which R3 is a monovalent, optionally substituted, SiC-bonded hydrocarbon radical having 1 to 30 carbon atoms, R4 is a hydrogen atom or a monovalent, optionally substituted hydrocarbon radical having 1 to 4 carbon atoms, a is 0, 1, 2 or 3 and b is 0, 1, 2 or 3, with the proviso that the sum total of a+b is ≤3 and, in less than 50% of all units of formula (II), the sum total of a+b=2, optionally a further organopolysiloxane (Ad), optionally water-insoluble organic compound (Ae) and optionally catalyst (Af), (B) 10 to 45 parts by weight of a waxy additive containing a monoester (B′) of glycerol and a fatty acid that is free of a polysiloxane-containing additive and that contains less than 5% by weight of a triester (B″) of glycerol and a fatty acid, (C) 10 to 50 parts by weight of a polycarboxylate binder that has a pH of 3 or less when it is dissolved in water, (D) 120 to 5000 parts by weight of at least one pulverulent carrier material, with the proviso that the carrier material contains less than 50% by weight of alkaline carrier material.

The invention relates to defoamer powder which contains, in addition to a defoamer formulation, a waxy non-silicone-containing component, a polycarboxylate binder and a pulverulent, water-soluble carrier material, to the production method thereof, and to the use thereof for the defoaming of media, preferably aqueous media, in particular aqueous surfactant formulations.

In many liquid, in particular aqueous, systems that contain surface-active compounds as desirable or else undesirable constituents, foam formation can cause problems when these systems are brought into more or less intensive contact with gaseous substances, for example in the sparging of wastewaters, in the intensive stirring of liquids, in distillation, washing or dyeing processes, or in filling operations.

This foam can be controlled by mechanical means or by the addition of defoamers. In this context, siloxane-based defoamers have been found to be particularly useful. Defoamers based on siloxanes are produced for example according to U.S. Pat. No. 3,383,327 A by heating hydrophilic silica in polydimethylsiloxanes. Polyorganosiloxanes having pendant relatively long-chain n-alkyl groups are also described as a basis for producing effective defoamers in US 2009/0137446 A1.

When using solid products, such as in detergents and cleaning compositions, in agrochemical products and in pharmaceutical formulations, use is primarily made of pulverulent defoamers. It is advantageous in this case to convert the defoamers, which are normally present as oily, viscous liquids, into powder form, which can be effected by adsorption of the defoamer onto solid carrier materials. In the case of the use in washing powders, it is particularly advantageous if the carrier materials used do not hinder the washing process or are detergent constituents themselves. A feature common to most of the defoamer powders obtained by simply applying the defoamers to a carrier material is that when stored they quickly lose efficacy, in particular in the presence of alkaline compounds.

In order to counteract this disadvantage, various solutions have been proposed. One possible solution includes the encapsulation or coating of the carrier material with the aim of better fixing of the defoamer. For this purpose, EP 0 995 473 A1 proposes the use of acidic polycarboxylates in combination with polyether-functionalized polysiloxanes on the carrier material zeolite.

EP 0 210 731 A2 describes the use of monoesters of glycerol as waxy additives. Storage stability can be demonstrated if the described monoesters of glycerol are used in excess relative to the polydimethylsiloxane-based defoamer.

WO 2004/018073 A1 describes defoamers based on polyorganosiloxanes having pendant functionalization with alpha-methylstyryl groups supported on sodium carbonate, starch or zeolite, where a glycerol triester, such as glycerol tristearate, is necessarily used as additive. The additives have a positive effect on the efficacy of the defoamer powders when used for foam control of washing powders. No statement is made about a storage stability.

WO 2004/018074 A1 describes defoamer powders in which waxy glycerol triesters are likewise used as additive. Partly in combination with further, more polar additives, for example glycerol monoesters, alkylphenols, fatty alcohols or fatty acids, the glycerol triesters are sprayed together with the defoamer onto a carrier, in particular sodium carbonate or starch. The amount of additives is at least 50% by weight based on the defoamer. It was also possible here to demonstrate a positive effect on the efficacy of the defoamer powders when used for foam control of washing powders. There is likewise no statement made in relation to the storage stability.

The disadvantage of the described solutions is the in some cases considerable amounts of the additionally required organic additives, their lack of storage stability in a solid surfactant matrix and their suboptimal aqueous solubility or aqueous dispersibility.

The object of the invention was therefore to provide defoamer powders which contain, in addition to the defoamer formulation and the carrier material, only small amounts of additional constituents, and have an excellent storage stability and an outstanding aqueous solubility or dispersibility. In particular, the defoamer powders produced should be able to be used in detergents and cleaning compositions.

The invention provides defoamer powders containing
(A) 100 parts by weight of a defoamer formulation containing
(Aa) a polysiloxane containing units of formula (I)

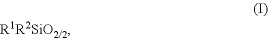

in which
R¹ is identical or different and is a monovalent, optionally branched, SiC-bonded hydrocarbon radical having 1 to 5 carbon atoms,
R² is identical or different and is a monovalent, optionally branched, SiC-bonded hydrocarbon radical having 6 to 30 carbon atoms,
(Ab) a filler,
(Ac) an organopolysiloxane resin composed of units of the general formula

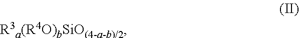

in which
R³ is identical or different and is a monovalent, optionally substituted, SiC-bonded hydrocarbon radical having 1 to 30 carbon atoms,
R⁴ is identical or different and is a hydrogen atom or a monovalent, optionally substituted hydrocarbon radical having 1 to 4 carbon atoms,
a is 0, 1, 2 or 3 and
b is 0, 1, 2 or 3,
with the proviso that the sum total of a+b is ≤3 and in less than 50% of all units of formula (II) in the
organopolysiloxane resin the sum total of a+b=2, optionally
(Ad) a further organopolysiloxane consisting of units of formula (III) and (IV)

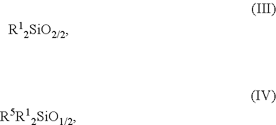

in which
R¹ has the definition given for it above,
R⁵ may be identical or different and may be R¹ or —OR⁶, where
R⁶ is a hydrogen atom or a monovalent, optionally substituted hydrocarbon radical having 1 to 25 carbon atoms,
optionally
(Ae) a water-insoluble organic compound,
optionally
(Af) an alkaline or acidic catalyst or the reaction product thereof with components (Aa) to (Ad)
(B) 10 to 45 parts by weight, based on 100 parts by weight of the defoamer formulation (A), of a waxy additive containing a monoester (B′) of glycerol and a fatty acid that is free of a polysiloxane-containing additive and that contains less than 5% by weight of a triester (B″) of glycerol and a fatty acid,
(C) 10 to 50 parts by weight, based on 100 parts by weight of the defoamer formulation (A), of a polycarboxylate binder that has a pH of 3 or less when it is dissolved in water,
(D) 120 to 5000 parts by weight, based on 100 parts by weight of the defoamer formulation (A), of at least one pulverulent carrier material, with the proviso that the carrier material contains less than 50% by weight of alkaline carrier material, preferably less than 40% by weight of alkaline carrier material, more preferably less than 25% by weight of alkaline carrier material.

The term “defoamer powders” should be understood to mean both pulverulent and granulated products.

It has now surprisingly been found that the defoamer powders having such a composition feature a significantly improved storage stability in washing powders as well as a significantly improved water solubility or water dispersibility in the washing solution with simultaneously low use of additional agents in comparison with the prior art.

The defoamer powders according to the invention preferably contain 10 to 42 parts by weight of the waxy additive (B), 10 to 47 parts by weight of the polycarbonate binder (C) and 200 to 2000 parts by weight of the pulverulent carrier material (D), in each case based on 100 parts by weight of the defoamer formulation (A), and particularly preferably 13 to 40 parts by weight of the waxy additive (B), 13 to 45 parts by weight of the polycarboxylate binder (C) and 300 to 1200 parts by weight of the pulverulent carrier material (D), in each case based on 100 parts by weight of the defoamer formulation (A).

The defoamer powders according to the invention preferably essentially consist of components (A), (B), (C) and (D).

Preferably, the defoamer formulation (A) consists of components (Aa), (Ab), (Ac) and optionally components (Ad), (Ae) and (Af).

Preferably, the defoamer formulations (A) contain
(1) at least 55% by weight, preferably at least 65% by weight, particularly preferably at least 75% by weight, and preferably at most 97% by weight, more preferably at most 90% by weight, particularly preferably at most 85% by weight, of polysiloxanes (Aa),
(2) at least 1% by weight, preferably at least 2% by weight, particularly preferably at least 3% by weight, and preferably at most 15% by weight, more preferably at most 12% by weight, particularly preferably at most 10% by weight, of fillers (Ab),
(3) at least 1% by weight, preferably at least 2% by weight, particularly preferably at least 3% by weight, and preferably at most 15% by weight, more preferably at most 12% by weight, particularly preferably at most 10% by weight, of organopolysiloxane resins (Ac) composed of units of formula (II),
(4) at least 0% by weight and preferably at most 15% by weight, more preferably at most 10% by weight, particularly preferably at most 7.5% by weight, of organopolysiloxanes (Ad) consisting of units of formula (III) and (IV),
(5) at least 0% by weight and preferably at most 15% by weight, more preferably at most 10% by weight, particularly preferably at most 7.5% by weight, of water-insoluble organic compounds (Ae),
and
(6) at least 0% by weight, preferably at least 0.05% by weight, particularly preferably at least 0.18 by weight, and preferably at most 1% by weight, more preferably at most 0.5% by weight, particularly preferably at most 0.3% by weight, of alkaline or acidic catalysts (Af) or the reaction products thereof with components (Aa) to (Ad).

Preferably, the organopolysiloxanes (Aa) used in the defoamer formulations (A) are those of formula (VIII)

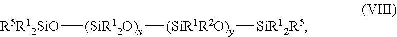

where
R¹, R² and R⁵ have the definition given for them above, x is greater than or equal to 0 or on average less than 200, preferably less than 100, particularly preferably less than 50, y is on average greater than 5, preferably greater than 10, and less than 200, preferably less than 100, particularly preferably less than 50.

Organopolysiloxanes (Aa) may additionally comprise branches by containing units of formula (IX) and (X).

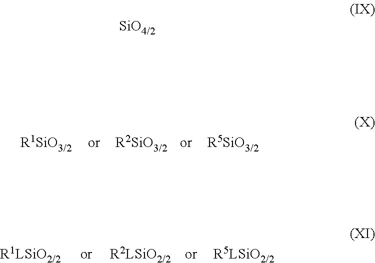

where
R¹, R² and R⁵ have the definition given for them above and L is a divalent structure that joins two organopolysiloxane chains to one another.
L may be an alkylene group, such as an ethylene, a propylene, a butylene, a hexylene, an octylene group, preferably a hexylene or octylene group, a divalent aromatic group, such as the 1,2-bisethylenebenzene, the 1,4-bisethylenebenzene group or the 1,8-bisethylenenaphthalene group, a cycloalkylene group, such as the 1,4-bisethylenecyclohexane group or a divalent organosiloxane chain.

Examples of hydrocarbon radicals R¹ are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical; and cycloalkyl radicals, such as the cyclopentyl radical.

Preferred examples of R¹ are the methyl and ethyl radicals. A particularly preferred example is the methyl radical.

Examples of hydrocarbon radicals R² are alkyl radicals, for example hexyl radicals, such as the n-hexyl radical, heptyl radicals, such as the n-heptyl radical, octyl radicals, such as the n-octyl radical and isooctyl radicals, such as the 2,2,4-trimethylpentyl and the 2-ethylhexyl radical, nonyl radicals, such as the n-nonyl radical, decyl radicals, such as the n-decyl radical, dodecyl radicals, such as the n-dodecyl radical, tetradecyl radicals, such as the n-tetradecyl radical, hexadecyl radicals, such as the n-hexadecyl radical and octadecyl radicals, such as the n-octadecyl radical; cycloalkyl radicals, such as the cyclohexyl, cycloheptyl, methylcyclohexyl and 4-ethylcyclohexyl radical; aryl radicals, such as the phenyl, naphthyl, anthryl and phenanthryl radical; alkaryl radicals, such as o-, m-, p-tolyl radicals, xylyl radicals and ethylphenyl radicals; and aralkyl radicals, such as the benzyl radical, the 2-phenylpropyl radical and the alpha- and the beta-phenylethyl radical.

Preferred examples of R² are the n-octyl radical, the n-decyl radical, the n-dodecyl radical, the n-tetradecyl radical, the n-hexadecyl radical, the n-octadecyl radical, the phenyl radical, the benzyl radical and the 2-phenylpropyl radical. Particularly preferred examples are the n-octyl radical, the n-dodecyl radical, the phenyl radical and the 2-phenylpropyl radical.

Examples, preferred examples and particularly preferred examples of R⁵ are the examples, preferred examples and particularly preferred examples of R¹ or radicals of the formula —OR⁶.

Examples of R⁶ are the hydrogen atom or alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl and the 2-ethylhexyl radical, nonyl radicals, such as the n-nonyl radical, decyl radicals, such as the n-decyl radical, dodecyl radicals, such as the n-dodecyl radical, tetradecyl radicals, such as the n-tetradecyl radical, hexadecyl radicals, such as the n-hexadecyl radical and octadecyl radicals, such as the n-octadecyl radical; and cycloalkyl radicals, such as cyclopentyl, cyclohexyl, cycloheptyl, methylcyclohexyl and 4-ethylcyclohexyl radical.

Preferred examples of R⁶ are the hydrogen atom or methyl and ethyl radicals.

Particularly preferred examples are the hydrogen atom or the methyl radical.

Preferably, the fillers (Ab) used in the defoamer formulations (A) have a BET surface area of 20 to 1000 m²/g. Preferably, the fillers (Ab) have a particle size of less than 10 μm and an agglomerate size of less than 100 μm.

Examples of fillers (Ab) are silicon dioxide (silicas), titanium dioxide, aluminum oxide, metal soaps, ground quartz, PTFE powder, fatty acid amides, for example ethylenebisstearamide, and finely divided hydrophobic polyurethanes.

Preferably used as fillers (Ab) are silicon dioxide (silicas), titanium dioxide or aluminum oxide having a BET surface area of 20 to 1000 m²/g. Preferably, these fillers have a particle size of less than 10 μm and an agglomerate size of less than 100 μm.

Preferred as fillers (Ab) are silicas, in particular those having a BET surface area of 50 to 800 m²/g. These silicas may be fumed or precipitated silicas. Both pretreated silicas, i.e. hydrophobic silicas, and hydrophilic silicas are usable as fillers (2). Examples of commercially available hydrophobic silicas that may be used according to the invention are HDK® H2000, a fumed hexamethyldisilazane-treated silica having a BET surface area of 140 m²/g (commercially available from Wacker Chemie AG, Germany) and a precipitated polydimethylsiloxane-treated silica having a BET surface area of 90 m²/g (commercially available under the name “Sipernat® D10” from Evonik, Germany).

Hydrophilic silicas may also be hydrophobized in situ if this is advantageous for the desired efficacy of the defoamer formulation. A number of processes for the hydrophobization of silicas are known. The in situ hydrophobization of the hydrophilic silica may be effected for example by heating the silica dispersed in component (Aa) or in a mixture of components (Aa), (Ac), optionally (Ad) and optionally (Ae) to temperatures of 100° C. to 200° C. for several hours. The reaction here may optionally be assisted by the addition of catalysts (Af) and of hydrophobizing agents, such as short-chain OH-terminated polydimethylsiloxanes, silanes or silazanes.

Component (Ac) used in the defoamer formulations (A) is preferably silicone resins composed of units of formula (II), in which preferably in less than 30%, more preferably in less than 58, of the units in the resin the sum total of a+b is equal to 2.

Preferably, R³ is a hydrocarbon radical having 1 to 30 carbon atoms.

Examples of hydrocarbon radicals R³ are alkyl radicals, such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl and the 2-ethylhexyl radical, nonyl radicals, such as the n-nonyl radical, decyl radicals, such as the n-decyl radical, dodecyl radicals, such as the n-dodecyl radical, tetradecyl radicals, such as the n-tetradecyl radical, hexadecyl radicals, such as the n-hexadecyl radical and octadecyl radicals, such as the n-octadecyl radical; cycloalkyl radicals, such as the cyclopentyl, cyclohexyl, cycloheptyl, methylcyclohexyl and 4-ethylcyclohexyl radical; aryl radicals, such as the phenyl, naphthyl, anthryl and phenanthryl radical; alkaryl radicals, such as o-, m-, p-tolyl radicals, xylyl radicals and ethylphenyl radicals; and aralkyl radicals, such as the benzyl radical, the 2-phenylpropyl radical and the alpha- and the beta-phenylethyl radical. Preferred examples of radicals R³ are the methyl, ethyl and phenyl radical.

Particularly preferred examples of the radical R³ is the methyl radical.

Examples of radicals R⁴ are the hydrogen atom and alkyl radicals, such as the methyl, ethyl, n-propyl, isopropyl and n-butyl radical.

The radical R⁴ is preferably a hydrogen atom or a methyl or ethyl radical.

Preferably, the organopolysiloxane resins (Ac) composed of units of formula (II) are

MQ resins composed of units of the formulae

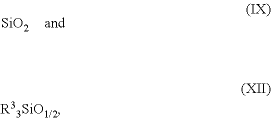

where R³ has the definition given for it above.

The molar ratio of M to Q units is preferably in the range from 0.5 to 2.0, more preferably in the range from 0.6 to 1.0. In addition to the M and Q units, the MQ resins may optionally also contain small amounts of R³SiO_{3/2} or (R⁴O)SiO_{3/2} (T) units or R³₂SiO_{2/2} (D) units, in amounts from preferably 0.01 to 20 mol %, more preferably 0.01 to 5 mol %, based on the sum total of all siloxane units, where R³ and R⁴ have the definition given for them above. These MQ resins may also contain up to 10% by weight of free Si-bonded hydroxyl or alkoxy groups, such as methoxy or ethoxy groups.

Preferably, these organopolysiloxane resins (Ac) have a viscosity of greater than 1000 mPa's or are solids at 25° C. and 101.425 kPa. The weight-average molecular weight determined by gel permeation chromatography (based on a polystyrene standard) of these resins is preferably 200 to 200 000 g/mol, in particular 1000 to 20 000 g/mol.

Organopolysiloxanes (Ad) that differ from polysiloxanes (Aa) may optionally be used in the defoamer formulations (A).

Preferably, the organopolysiloxanes (Ad) are those of formula (IXX)

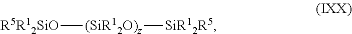

where
R¹ and R⁵ have the definition given for them above,
z is on average greater than 5, preferably greater than 10, and less than 500, preferably less than 200, particularly preferably less than 100.

Water-insoluble organic compounds (Ae) may optionally be used in the defoamer formulations (A).

In the context of the present invention, the term “water-insoluble” should be understood to mean a solubility in water at 25° C. and a pressure of 101.425 kPa of at most 3 percent by weight.

Optionally used component (Ae) is preferably water-insoluble organic compounds having a boiling point of greater than 100° C. at the pressure of the surrounding atmosphere, i.e. at 900 to 1100 hPa, and a melting point of less than 35° C., in particular those selected from mineral oils, natural oils, isoparaffins, polyisobutylenes, residues from oxo alcohol synthesis, esters of low molecular mass synthetic carboxylic acids, such as pentane-1,3-diol diisobutyrate, fatty acid esters, such as octyl stearate, octyl oleate, isopropyl laurate, methyl laurate or isopropyl myristate, fatty alcohols that are liquid at temperatures of greater than 35° C., ethers of low molecular mass alcohols, phthalates and esters of phosphoric acid.

Examples of alkaline catalysts (Af) are alkali metal hydroxides and alkaline earth metal hydroxides, such as NaOH, KOH, CsOH, LiOH and Ca(OH)₂. Examples of acidic catalysts (Af) are hydrochloric acid, sulfuric acid and phosphonitrile chlorides.

The reaction products of (Af) with components (Aa) to (Ad) are for example the product of the silica preferred as filler (Ab) with alkali metal hydroxides, such as potassium silicate or sodium silicate.

The metered addition of the catalysts may be effected in typical organic solvents such as alcohols (such as methanol, ethanol, isopropanol) or esters (such as ethyl acetate).

Components (Aa) to (Af) used in the defoamer formulations (A) may each be one type of such a component or else a mixture of at least two types of a respective component.

The defoamer formulations (A) have a viscosity of preferably 100 to 2 000 000 mPa·s, more preferably of 500 to 80 000 mPa·s, particularly preferably of 1000 to 15 000 mPa·s, in each case at 25° C. and 101.425 kPa.

The defoamer formulations (A) according to the invention may be produced by known methods, such as by mixing all components, for example using high shear forces in colloid mills, dissolvers or rotor-stator homogenizers. The mixing process may be performed at reduced pressure in order to prevent the incorporation of air, which is present for example in highly dispersed fillers. If required, this may be followed by the in situ hydrophobization of the fillers.

It is also possible to first initially charge and optionally heat components (Aa) and then to successively add components (Ab), (Ac), optionally (Ad), optionally (Ae) and optionally (Af).

In a preferred embodiment, component (Ac) is added in dissolved form as a solution in component (Ad) or (Ae) or portions of component (Ad) or (Ae).

The waxy additive (B) used is an organic material having a melting point in the range from 35° C. to 85° C., the main constituent of which is a monoester of glycerol and a fatty acid (also referred to as 1-monoacylglycerol).

In particular, these are monoesters of glycerol and aliphatic fatty acids having a carbon chain containing 12 to 20 carbon atoms. This includes products in both their racemic and optically active form.

Examples of such monoesters are glycerol monolaurate, glycerol monomyristate, glycerol monopalmitate and glycerol monostearate. A particularly preferred example of a monoester is glycerol monostearate.

The waxy additive (B) used may be an organic material that has a melting point in the range from 35° C. to 85° C. and as a result of the production is a mixture of several components, the main component of which is a monoester of glycerol and a fatty acid. Industrial products of 1-monoacylglycerols are thus generally mixtures of a 1-monoacylglycerol and a diacylglycerol with different monoacylglycerol content. Furthermore, these industrial products may also contain small proportions of triacylglycerol, free glycerol and also free fatty acid.

In the case of glycerol monostearate, it is mostly a mixture of glycerol monostearate, glycerol distearate and possibly glycerol monopalmitate and small proportions of glycerol tristearate as well as free glycerol (in the case of non-emulsifying or non-self-emulsifying glycerol monostearate) or also a certain amount of soap (in the case of self-emulsifying glyceryl monostearate).

The waxy additive (B) used may also be an organic material that has a melting point in the range from 35° C. to 85° C. and in which an additional waxy organic material has been deliberately added to the monoester of glycerol and a fatty acid as the main component.

This additional waxy organic material, which is not an ester of fatty acid and glycerol, has a melting point in the range from 35° C. to 85° C.

Examples of an additional waxy material are semisynthetic waxes such as amide waxes (for example stearamide, behenamide, erucamide, oleamide), alcohol waxes or ketone waxes or synthetic waxes such as polyolefin waxes or waxy hydrocarbons (for example hard paraffins having a melting point from 50° C. to 62° C.).

Irrespective of whether as a result of the production or whether an additional waxy material is used, the content of 1-monoacylglycerol is preferably greater than or equal to 30% by weight, more preferably greater than or equal to 50% by weight and in particular greater than or equal to 70% by weight and the content of triacylglycerol is preferably less than 58 by weight in the total mixture of the waxy component (B) used.

What is essential for the defoamer powders according to the invention is the combination of the waxy additive (B) and at least one polycarboxylate binder (C) that has a pH of 3 or less when it is dissolved or dispersed in water.

It has been found that this combination is essential for good storage stability of the defoamer powder according to the invention in a washing powder.

The polycarboxylate binder (C) is a water-soluble or water-dispersible polymer, homopolymer, copolymer or a salt thereof. They comprise at least 60 percent by weight of segments of the general formula

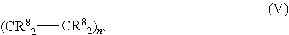

where
n assumes a value between 10 and 100 000, preferably between 20 and 10 000, particularly preferably between 30 and 1000,
R⁸ is selected from hydrogen, (optionally substituted) hydrocarbon radicals having 1 to 30 carbon atoms, carboxyl groups or salts thereof, and groups of the general formula

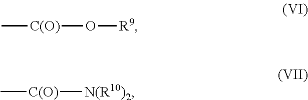

where
R⁹ is an optionally functionalized hydrocarbon radical having 1 to 30 carbon atoms and
R¹⁰ is either hydrogen, the radical R⁹ or R¹¹—SO₃X, where
R¹¹ is a divalent alkylene radical having 1 to 12 carbon atoms and
X is a hydrogen atom or a cation,
with the proviso that at least 5 mol %, preferably at least 10 mol %, particularly at least 15 mol % of the radicals R& are acidic groups selected from the carboxyl group or salts thereof and groups containing a sulfonyl group or salts thereof, preferably selected from the carboxyl group and salts thereof.

The radicals R⁸ may be identical or different.

Examples of radicals R⁸ are the hydrogen atom, monovalent (optionally substituted) alkyl, aryl, aralkyl and cycloaliphatic hydrocarbon radicals, such as methyl, ethyl, heptyl, octyl, 2-ethylhexyl, decyl, isodecyl, dodecyl, lauryl, myristyl, stearyl, phenyl, (sulfonyl)phenyl, such as (4-sulfonyl)phenyl or (2-sulfonyl)phenyl, 1-naphthyl, and (sulfonyl)naphthyl radicals, carboxyl group or groups of formulae (VI) and (VII).

Preferred radicals R⁸ are the hydrogen atom, the methyl radical, the ethyl radical, the (sulfonyl)phenyl radical, the carboxyl group or groups of formulae (VI) and (VII).

The radicals R⁹ may be identical or different monovalent alkyl, aryl, aralkyl and cycloaliphatic hydrocarbon radicals.

Examples of radicals R⁹ are the methyl, the ethyl, the n-butyl, the isobutyl, the tert-butyl, the 2-ethylhexyl, the lauryl, the stearyl, the benzyl, the isopropyl, the neopentyl, the cyclohexyl, the 2-hydroxyethyl and the 2-hydroxypropyl group.

The radicals R¹⁰ may be identical or different and be either hydrogen, the radical R⁹ or R¹¹—SO₃X.

Examples of the divalent alkylene radical R¹¹ are the methylene group, the 1,2-ethylene group, the 1,3-propylene group, the 1,2-propylene group or the (2-methyl-) 1,2-propylene group. Examples of X are the hydrogen atom or a cation, such as the sodium, the potassium, the calcium, the magnesium, the lithium cation or ammonium cations, for example derived from ammonia, monoethanolamine, diethanolamine, triethanolamine or isopropylamine.

Examples of preferred segments corresponding to the general formula (V) are:

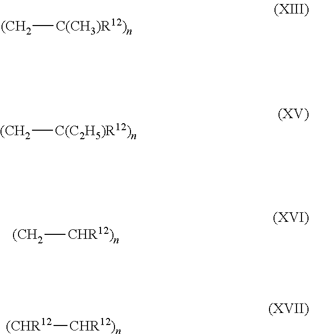

where R¹² is selected from the groups

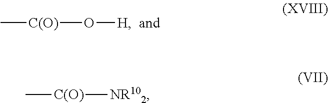

where R¹⁰ has the definition given for it above.

The carboxyl group (XVIII) as well as the sulfonyl group may also be partially neutralized by bases, preferably bases with a singly positively charged cation, such as alkali metal cations or ammonium cations, with it nevertheless still being necessary to meet the condition that the binder (C) has a pH of 3 or less when it is dissolved in water.

Examples of monomers that result in these mentioned structures are acrylic acid, methacrylic acid, ethacrylic acid, maleic acid, fumaric acid, itaconic acid, aconi acid, mesaconic acid, cetraconic acid, methylenemalonic acid, 4-vinylbenzenesulfonic acid and 2-acrylamido-2-methylpropanesulfonic acid (AMPS).

Usable as monomers are also maleic anhydride or maleimide. In this case, it is preferred that the incorporated anhydride or imide groups are reacted completely or partially with water, alcohols, amines or ammonia solution to form carboxyl, ester and/or amide groups.

Preferred examples of monomers that result in these mentioned structures are acrylic acid, methacrylic acid, ethacrylic acid, maleic acid, itaconic acid, aconi acid, mesaconic acid, 2-acrylamido-2-methylpropanesulfonic acid (AMPS), maleic anhydride and maleimide.

Particularly preferred examples of monomers that result in these mentioned structures are acrylic acid, maleic acid, 2-acrylamido-2-methylpropanesulfonic acid (AMPS) and maleic anhydride.

Copolymerization with relatively small amounts of monomeric materials that do not contain any carboxylic acid, i.e. methyl acrylate, ethyl acrylate, n-butyl acrylate, isobutyl acrylate, tert-butyl acrylate, 2-ethylhexyl acrylate, lauryl acrylate, stearyl acrylate, benzyl acrylate, methyl methacrylate, ethyl methacrylate, isopropyl methacrylate, n-butyl methacrylate, isobutyl methacrylate, tert-butyl methacrylate, neopentyl methacrylate, 2-ethylhexyl methacrylate, lauryl methacrylate, stearyl methacrylate, cyclohexyl methacrylate, benzyl methacrylate, 2-hydroxyethyl acrylate, 2-hydroxypropyl acrylate, 2-hydroxyethyl methacrylate, 2-hydroxypropyl methacrylate, butane-1,4-diol monoacrylate, N,N-dimethylaminoethyl acrylate, N,N-dimethylaminoethyl methacrylate, acrylamide, methacrylamide, vinyl methyl, vinyl methyl ether, styrene and ethylene, is not harmful for the use of the polycarboxylates in the foam control agents according to the invention. Depending on the type of the polycarboxylate, this content may be kept low or the content may be up to about 40 percent by weight of the total polymer or copolymer.

Such and similar compounds (C) that may be used in the context of the present invention are known and commercially available; for example Sokalan® PA80S and Sokalan® PA110S (BASF, Germany) that have a pH of about 1.5, acrylic-maleic copolymers, for example Sokalan® CP12S (BASF, Germany) having a pH of about 1, and modified polyacrylic acid polymers, for example Sokalan® CP10S and 13S (also BASF, Germany) that have a pH of about 1.5 or Aquatreat® AR-540 (Nouryon, copolymer of acrylic acid and sulfonated monomers).

The defoamer powders according to the invention preferably contain carrier materials (D) that are not alkaline carrier materials. Alkaline carrier materials are those that result in an alkaline pH, i.e. a pH of greater than or equal to 11, when dissolved or dispersed in water.

This is determined from a 0.02% by weight solution or a 5% by weight slurry.

It has been found that the storage stability of the defoamer powders according to the invention in washing powder is significantly improved when predominately non-alkaline carrier materials are used.

The carrier materials (D) present in the defoamer powder according to the invention may each be one type of such a component or else a mixture of at least two types of a respective component.

In the case that only one type of a component is used as carrier material, this should be a non-alkaline carrier material.

In the case that several components are used as carrier material, a non-alkaline carrier material should be the main component. This is the case when the proportion of non-alkaline carrier materials is greater than 50% by weight, preferably greater than 60% by weight, particularly preferably greater than 75% by weight of the total amount of carrier materials (D).

Examples of non-alkaline carrier materials are phosphates, for example pulverized or granular sodium tripolyphosphate, sodium sulfate, sodium bicarbonate, sodium citrate, sodium acetate or cellulose derivatives such as sodium carboxymethyl cellulose.

Examples of alkaline carrier materials that may be used in amounts of less than 50% by weight, preferably less than 40% by weight, particularly preferably less than 25% by weight, are sodium carbonate, zeolites, for example zeolite A or zeolite X, aluminosilicates or silicates, for example magnesium silicate.

Particular preference is given to those carrier materials that have good water solubility, such as sodium sulfate, sodium bicarbonate, sodium citrate, sodium acetate and cellulose derivatives such as sodium carboxymethyl cellulose.

In the context of the present invention, there is good water solubility when there is a solubility in water at 25° C. and a pressure of 101.425 kPa of at least 3 percent by weight.

In the case that only one type of a component is used as carrier material, this should be a readily water-soluble carrier material.

In the case that several components are used as carrier material, a readily water-soluble carrier material should be the main component. This is the case when the proportion of readily water-soluble carrier materials is greater than 50% by weight, preferably greater than 60% by weight, particularly preferably greater than 75% by weight of the total amount of carrier materials (D).

It has been found that the water solubility or water dispersibility of the defoamer powders according to the invention is significantly improved when a water-soluble carrier material is used as main component.

Examples of readily water-soluble carrier materials are phosphates, for example pulverized or granular sodium tripolyphosphate, sodium sulfate, sodium bicarbonate, sodium citrate, sodium acetate or cellulose derivatives such as sodium carboxymethyl cellulose.

Examples of sparingly water-soluble carrier materials that may be used in amounts of less than 50% by weight, preferably less than 40% by weight, particularly preferably less than 25% by weight, are zeolites, for example zeolite A or zeolite X, aluminosilicates or silicates, for example magnesium silicate.

The invention further provides a process for producing the defoamer powders, in that
a premix, preferably in the form of a dispersion, in particular aqueous dispersion, of defoamer formulation (A), waxy additive (B) and binder (C) is produced and
this premix is mixed with the pulverulent carrier material.

The premix is preferably obtained by dispersing a, preferably aqueous, emulsion or dispersion of defoamer formulation (A) and waxy additive (B) in a, preferably aqueous, solution or dispersion of the binder (C).

The defoamer powders according to the invention may for example be produced by mixing a premix of the defoamer formulation (A) and the waxy additive (B) with the pulverulent carrier material (D), and subsequently or simultaneously incorporating a solution or dispersion of a binder (C).

Alternatively, it is also possible to produce an emulsion or dispersion of a premix of the defoamer formulation (A) and the waxy additive (B) in a solution or dispersion of a binder (C) in a known manner and to subsequently incorporate this onto the pulverulent carrier material (D).

This production method using an emulsion or dispersion of a premix of the defoamer formulation (A) and the waxy additive (B) in a solution or dispersion of a binder (C) is the favored procedure.

If required, the pulverulent composition obtained after the mixing may also be dried so that a free-flowing powder is ultimately obtained. The drying may be effected either directly in the mixer or subsequently in a separate dryer of a known design, for example a belt dryer, a spray dryer, a screw dryer, a paddle dryer or an adsorption dryer. The drying is preferably effected at a temperature of 60° C. to 150° C.

To produce the defoamer powders according to the invention, use may be made of various known mixers that can preferably be heated and/or evacuated in order to enable drying in the same unit.

Examples of suitable mixers are plowshare mixers, Z mixers, screw extruders or planetary mixers. The technology-related residual water content of the defoamer powder according to the invention is below 10% by weight, preferably below 5% by weight.

Preferably, the defoamer powders according to the invention are used in detergents and cleaning compositions.

However, they may be used wherever the intention is to control or prevent foam. One example of this is pulverulent crop protection products, in particular those that contain relatively large amounts of surface-active compounds. Alternatively, the defoamer powders according to the invention may advantageously be used in chemical processes or in wastewater treatment.

The metered addition of the defoamer powders according to the invention may be effected by simple mixing for example with the detergent. This is advantageously carried out at the point in time at which the detergent is mixed with further constituents, such as enzymes, bleaching agents. However, it is also possible to meter the defoaming powder according to the invention directly into the foaming medium.

The defoamer powders according to the invention are preferably used in surfactant-containing, solid media which result in foam formation when used in an aqueous environment, more preferably in detergents and cleaning compositions, in particular in solid (pulverulent or granular) detergents and cleaning compositions.

The invention therefore provides detergents or cleaning compositions containing the defoamer powders according to the invention.

The viscosity of the individual components, in particular components (Aa), is determined in accordance with DIN 53019-1 (2008-09) (Principles and measuring geometry), DIN 53019-2 (2001-2) (Viscosimeter calibration and determination of the uncertainty of measurement) and DIN 53019-3 (2008-09) (Errors of measurement and corrections) or in accordance with DIN EN ISO 3219 (1994) (Plastics—Polymers/resins in the liquid state or as emulsions or dispersions—Determination of viscosity using a rotational viscometer with defined shear rate) using an MCR 300 cone/plate viscometer (Paar-Physika) at 25° C. and a shear rate as indicated accordingly.

The viscosity of the defoamer formulation (A) is determined in accordance with DIN EN ISO 3219 using an MCR 300 cone/plate viscometer (Paar-Physika) at 25° C. and a shear rate of 50/s.

The amount of monoacylglycerol or triacylglycerol in commercially available monoacylglycerols is determined by means of liquid chromatography (HPLC) using a Phenomenix Luna 5μ C5 100 A (250×4.6 mm) HPLC column. The mobile phase used is a mixture of 0.05% aqueous trifluoroacetic acid and THE, with a gradient of 30% THF-100% THE being run at a flow of 1.0 ml/min and a column temperature of 30° C. Detection is performed by means of an evaporative light scattering detector (ELSD) (1.4 SLM—30° neb—30° C. evap—50% light source intensity).

10 mg of the samples is dissolved in 10 ml of THE, admixed with 1 ml of water and made up to a total of 10 ml with additional THF. Calibration is performed against chemically pure monoacylglycerols or triacylglycerols.

In the examples which follow, all figures for parts and percentages, unless stated otherwise, are based on weight. Unless stated otherwise, the examples which follow are conducted at a pressure of the surrounding atmosphere, i.e. at about 1000 hPa, and at room temperature, i.e. about 20° C., or a temperature which is established on combination of the reactants at room temperature without additional heating or cooling.

### EXAMPLE 1: PRODUCTION OF THE DEFOAMER FORMULATIONS (A)

### Production of the Defoamer Formulations (A1):

82.3 parts by weight of a trimethylsiloxy-terminated methyloctylsiloxane having an average chain length of 55 and a viscosity of 700 mPa·s (measured at 25° C. and a shear rate of 10/s), 5 parts of a fumed silica having a BET surface area of 300 m²/g (available under the name HDK® T30 from Wacker Chemie AG Munich), 5 parts of a hydrocarbon mixture having a boiling range of 235-270° C. (commercially available under the name Exxsol D 100 S from Staub & Co Nuremberg, Germany), 5 parts of a silicone resin that is solid at room temperature and consists of the following units (according to 29Si NMR and IR analysis): 40 mol % of (CH₃)₃SiO_{1/2}—, 50 mol % of SiO_{4/2}—, 8 mol % of C₂H₅OSiO_{3/2}— and 2 mol % of HOSiO_{3/2}—, this resin having a weight-average molar mass of 7900 g/mol (based on a polystyrene standard), and 0.7 parts of a 20% by weight solution of KOH in glycerol were mixed in a dissolver and heated to 110° C. for 4 hours. A defoamer formulation having a viscosity of 35 500 mPa·s (2.5 rpm, 25° C.) was obtained.

### Production of the Defoamer Formulations (A2):

The production method for the defoamer formulation (A1) is repeated, where 82.3 parts by weight of a trimethylsiloxy-terminated dodecylmethylsiloxane having an average chain length of 55 and a viscosity of 1100 mPa·s (measured at 25° C. and a shear rate of 10/s) is used as organopolysiloxane (Aa). A defoamer formulation (A2) having a viscosity of 28 700 mPa·s (2.5 rpm, 25° C.) was obtained.

### Production of the Defoamer Formulations (A3):

85 parts of a trimethylsiloxy-terminated dimethylsiloxy-(alpha-methylstyryl)methylsiloxy-methyloctylsiloxy copolymer having an average chain length of 60, a ratio of dimethylsiloxy units to (alpha-methylstyryl)methylsiloxy units to methyloctylsiloxy of 10 to 9 to 1 and a viscosity of 1500 mPa·s (measured at 25° C. and a shear rate of 10/s), 5 parts of the fumed silica as for defoamer formulation (A1), 5 parts of the hydrocarbon mixture as for defoamer formulation (A1), 5 parts of the silicone resin as for defoamer formulation (A1) and 0.7 parts of a 20% by weight methanolic KOH solution were mixed in a dissolver and heated to 110° C. for 4 hours. A defoamer formulation having a viscosity of 9500 mPa·s (2.5 rpm, 25° C.) was obtained.

### EXAMPLE 2: PRODUCTION OF THE DEFOAMER POWDERS ACCORDING TO THE INVENTION

### Production of the Defoamer Powder (P1):

10 parts of the defoamer formulation (A1) are mixed together with 1.25 parts of glycerol monostearate (available under the name GMS90 from Faci having a content of glycerol tristearate of less than 1% by weight (according to HPLC analysis)) at a temperature of 50° C. The mixture obtained is dispersed in 2.5 parts of a polyacrylic acid solution heated to 50° C. and having a pH of 2.5 (50% by weight solution of polyacrylic acid commercially available as Sokalan® CP 10 S from BASF). The result is a white, creamy, flowable dispersion. The dispersion obtained is added under high shear to a mixture of 72.5 parts of sodium sulfate and 15 parts of zeolite 4A. After drying at 80° C. to constant weight, the defoamer powder (P1) according to the invention is obtained.

### Production of the Defoamer Powder (P2):

Analogously to the description for defoamer powder (P1), a dispersion is produced from 3.75 parts of glycerol monostearate GMS90, 2.5 parts of Sokalan CP 10 S and 10 parts of the defoamer formulation (A1). Addition of this dispersion to a mixture of 70 parts of sodium sulfate and 15 parts of zeolite 4A and final drying gives the defoamer powder (P2).

### Production of the Defoamer Powder (P3):

Analogously to the description for defoamer powder (P1), a dispersion is produced from 1.25 parts of glycerol monostearate GMS90, 7.5 parts of Sokalan CP 10 S and 10 parts of the defoamer formulation (A1). Addition of this dispersion to a mixture of 70 parts of sodium sulfate and 15 parts of zeolite 4A and final drying gives the defoamer powder (P3).

### Production of the Defoamer Powder (P4):

Analogously to the description for defoamer powder (P1), a dispersion is produced from 3.75 parts of glycerol monostearate GMS90, 7.5 parts of Sokalan CP 10 S and 10 parts of the defoamer formulation (A1). Addition of this dispersion to a mixture of 70 parts of sodium sulfate and 15 parts of zeolite 4A and final drying gives the defoamer powder (P4).

### Production of the Defoamer Powder (P5):

Analogously to the description for defoamer powder (P1), a dispersion is produced from 1.9 parts of glycerol monostearate GMS90, 1.9 parts of paraffin (melting range: 56-58° C.), 8.0 parts of Sokalan CP 10 S and 10 parts of the defoamer formulation (A1). Addition of this dispersion to a mixture of 67 parts of sodium sulfate and 15 parts of zeolite 4A and final drying gives the defoamer powder (P5).

### Production of the Defoamer Powder (P6):

Analogously to the description for defoamer powder (P1), a dispersion is produced from 3.8 parts of glycerol monostearate GMS90, 8.0 parts of Sokalan CP 10 S and 10 parts of the defoamer formulation (A3). Addition of this dispersion to a mixture of 66 parts of sodium sulfate and 15 parts of zeolite 4A and final drying gives the defoamer powder (P6).

### Production of the Defoamer Powder (P7):

Analogously to the description for defoamer powder (P1), a dispersion is produced from 3.8 parts of glycerol monostearate GMS90, 8.0 parts of Sokalan CP 10 S and 10 parts of the defoamer formulation (A2). Addition of this dispersion to a mixture of 66 parts of sodium sulfate and 15 parts of zeolite 4A and final drying gives the defoamer powder (P7).

### EXAMPLE 3: PRODUCTION OF NON-INVENTIVE DEFOAMER POWDERS

### Production of the Defoamer Powder (VP1):

3.8 parts of glycerol monostearate GMS90 and 10 parts of the defoamer formulation (A1) are mixed with one another at 50° C. and the warm mixture is added to a mixture of 70 parts of sodium sulfate and 15 parts of zeolite 4A, with the result that the (non-inventive) defoamer powder (VP1) is obtained.

### Production of the Defoamer Powder (VP2):

Analogously to the description for defoamer powder (P1), a dispersion is produced from 3.8 parts of glycerol monostearate GMS90, 11.1 parts of a polyacrylic acid having a pH of 8.5 (45% by weight solution of polyacrylic acid commercially available as Sokalan® CP 10 from BASF) and 10 parts of the defoamer formulation (A1). Addition of this dispersion to a mixture of 66 parts of sodium sulfate and 15 parts of zeolite 4A and final drying gives the (non-inventive) defoamer powder (VP2).

### Production of the Defoamer Powder (VP3):

Analogously to the description for defoamer powder (P1), a dispersion is produced from 3.8 parts of glycerol monostearate GMS90, 8.0 parts of an acrylic acid-maleic acid copolymer having a pH of 8.0 (40% by weight solution of polyacrylic acid commercially available as Sokalan® CP 5 from BASF) and 10 parts of the defoamer formulation (A1). Addition of this dispersion to a mixture of 67 parts of sodium sulfate and 15 parts of zeolite 4A and final drying gives the (non-inventive) defoamer powder (VP3).

### Production of the Defoamer Powder (VP4):

Analogously to the description for defoamer powder (P1), a dispersion is produced from 3.8 parts of Steareth-4, 8.0 parts of Sokalan CP 10 S and 10 parts of the defoamer formulation (A1). Addition of this dispersion to a mixture of 66 parts of sodium sulfate and 15 parts of zeolite 4A and final drying gives the (non-inventive) defoamer powder (VP4).

### Production of the Defoamer Powder (VP5):

Analogously to the description for defoamer powder (P1), a dispersion is produced from 10.0 parts of Sokalan CP 10 S and 10 parts of the defoamer formulation (A1). Addition of this dispersion to a mixture of 70 parts of sodium sulfate and parts of zeolite 4A and final drying gives the (non-inventive) defoamer powder (VP5).

### Production of the Defoamer Powder (VP6):

A mixture of 3.8 parts of glycerol monostearate GMS90 and 10 parts of the defoamer formulation (A1) are together with 8.0 parts of Sokalan CP 10 S on parts of sodium carbonate and final drying the (non-inventive) defoamer powder (VP6) is obtained.

### Production of the Defoamer Powder (VP7):

10 parts of the defoamer formulation (A1) are dispersed in 8.0 parts of Sokalan CP 10 S. Addition of this dispersion to 85 parts of zeolite 4A and final drying gives the (non-inventive) defoamer powder (VP7).

### Production of the Defoamer Powder (VP8):

10 parts of the defoamer formulation (A3) are mixed with 3.8 parts of glycerol monostearate GMS 90, and the mixture is dispersed in 8.0 parts of Sokalan CP 10 S. Addition of this dispersion to 82 parts of maize starch and final drying gives the (non-inventive) defoamer powder (VP8).

### EXAMPLE 4

Tests of Defoamer Efficacy in the Washing Machine 0.5% by weight of defoamer powders was added to 130 g of a washing powder ECE-2 from WFK. The washing powder was then placed into a drum washing machine (model: Miele Novotronik W918 without Fuzzy Logic) together with 3500 g of clean cotton laundry. The washing program is then started. The program runs at a temperature of 40° C. and a water hardness of 3° GH. The foam height is recorded over a period of 55 minutes. The average foam score is determined from the foam scores ascertained over the entire period (0% no foam measurable up to 100% overfoaming). The lower this score, the more effective the defoamer powder over the entire period.

Storage tests in the washing powder ECE-2 are carried out as follows:
0.5% by weight of defoamer powders is added to 130 g of the washing powder and thoroughly mixed. The mixture is placed into a PE bag having a film thickness of 50 μm, the PE bag is closed and stored in a climatic chamber for 4, 8 or 12 weeks at 35° C./70% humidity. After storage, the contents of a bag are examined as above in the drum washing machine to check the foam control. Each foam score determination is an average value of several individual measurements.

TABLE 1
Defoamer effect of 0.05% of the defoamer powders according to the
invention in the washing powder ECE-2 with and without storage:

| Defoamer | Average foam score | Average foam score after |
|---|---|---|
| powder | without storage | storage for 12 weeks |
| P1 | ++ | ++ |
| P2 | ++ | ++ |
| P3 | ++ | ++ |
| P4 | ++ | ++ |
| P5 | ++ | ++ |

0-10% foam: ++
11-20% foam: +
21-40% foam: ∘
41-60% foam: −
>60% foam: −−

All defoamer powders according to the invention have an excellent defoamer effect in the washing powder ECE-2. Even after storage for 12 weeks, the defoamer powders still exhibit an outstanding defoamer effect.

TABLE 2
Defoamer effect of 0.05% of the non-inventive defoamer powder
VP1 in the washing powder ECE-2 with and without storage:

| Defoamer | Average foam score | Average foam score after |
|---|---|---|
| powder | without storage | storage for 12 weeks |
| VP1 | ++ | −− |

In the case that no polyacrylic acid is used (as described in EP 0 210 731, EP 1 534 403 and EP 1 528 954), the (non-inventive) antifoam powder (VP1) does exhibit an outstanding defoamer efficacy without storage. However, the defoamer efficacy breaks down completely after storage for 12 weeks. The combination of acidic polyacrylic acid and glycerol monostearate (as used in the defoamer powders P1 to P5 according to the invention) is therefore necessary to achieve a very good storage stability.

TABLE 3
Defoamer effect of 0.05% of the non-inventive
defoamer powders VP2 and VP3 in the washing
powder ECE-2 with and without storage:

| Defoamer | Average foam score | Average foam score after |
|---|---|---|
| powder | without storage | storage for 8 weeks |
| VP2 | ++ | −− |
| VP3 | ++ | −− |

In the case that no acidic polyacrylic acid is used, there is likewise an outstanding defoamer efficacy without storage. However, the defoamer efficacy has completely broken down already after 8 weeks.

If, in contrast, an acidic polyacrylic acid is used (as in the defoamer powders P1 to P5 according to the invention), an outstanding storage stability is achieved.

TABLE 4
Defoamer effect of 0.05% of the non-inventive
defoamer powders VP4 and VP5 in the washing
powder ECE-2 with and without storage:

| Defoamer | Average foam score | Average foam score after |
|---|---|---|
| powder | without storage | storage for 12 weeks |
| VP4 | + | −− |
| VP5 | + | −− |

In the case that a stearyl polyether is used instead of the glycerol monostearate (VP4) or if the glycerol monostearate is completely dispensed with (VP5), a slightly worse efficacy is already exhibited without storage. The defoamer efficacy is significantly reduced after storage for 12 weeks.

If, in contrast, a glycerol monostearate is used (as in the defoamer powders P1 to P5 according to the invention), both an excellent efficacy without storage and an outstanding storage stability are achieved.

TABLE 5
Defoamer effect of 0.05% of the non-inventive defoamer powder
VP6 in the washing powder ECE-2 with and without storage:

| Defoamer | Average foam score | Average foam score after |
|---|---|---|
| powder | without storage | storage for 4 weeks |
| VP6 | ∘ | −− |

In the case that exclusively an alkaline carrier is used and that the polycarboxylate binder and the defoamer formulation are not added in the form of an aqueous premix, there is a weaker defoamer efficacy without storage. In addition, the defoamer efficacy has significantly broken down after storage for 8 weeks.

If, in contrast, the alkaline carrier is not the main component (as in the defoamer powders P1 to P5 according to the invention having approx. 18% by weight based on the total amount of carrier materials) and if the polycarboxylate binder is added together with the antifoam formulation as an aqueous premix to the carrier materials (as in the defoamer powders P1 to P5 according to the invention), there is an outstanding efficacy without storage, and the defoamer efficacy still exists even after storage for 12 weeks.

### EXAMPLE 5: DISPERSIBILITY OF THE DEFOAMER POWDERS

150 g of water is initially charged into a 250 ml glass bottle. The defoamer powder is added thereto and stirred with a spatula. A visual evaluation is performed after 10 s and after 60 s.

TABLE 6
Solubility/dispersibility of 0.1% by weight of defoamer
powders in water after 10 and 60 seconds:

| Defoamer | Visual evaluation | Visual evaluation |
|---|---|---|
| powder | after 10 seconds | after 60 seconds |
| P7 | Clear solution, little | Clear solution, sediment |
| | sediment | largely dissolved |
| VP7 | Cloudy solution, | Cloudiness has |
| | sediment | increased again |
| VP8 | Low cloudiness of the | Cloudiness of the solution |
| | solution, sediment | has increased again |

In the case that exclusively zeolite or else exclusively starch is used as carrier material (VP7 and VP8), there is low solubility. In both cases, the result is a cloudy solution that becomes even more cloudy over time.

In the case that a water-soluble carrier material (sodium sulfate) is used as main component (P7), the result is a clear solution. The sediment that arises at the beginning (but less than in the case of VP7 or VP8) largely dissolves over time. The use of water-soluble carrier materials as the main component of the defoamer powders according to the invention clearly exhibits an advantage over the prior art.

1-13. (canceled)

14. Defoamer powders, comprising:
(A) 100 parts by weight of a defoamer formulation comprising
(Aa) a polysiloxane containing units of formula (I) 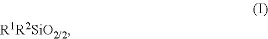
wherein R¹ may be identical or different and is a monovalent, optionally branched, SiC-bonded hydrocarbon radical having 1 to 5 carbon atoms, and
wherein R² may be identical or different and is a monovalent, optionally branched, SiC-bonded hydrocarbon radical having 6 to 30 carbon atoms,
(Ab) a filler,
(Ac) an organopolysiloxane resin composed of units of the general formula 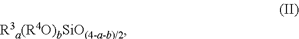
wherein R³ may be identical or different and is a monovalent, optionally substituted, SiC-bonded hydrocarbon radical having 1 to 30 carbon atoms,
wherein R⁴ may be identical or different and is a hydrogen atom or a monovalent, optionally substituted hydrocarbon radical having 1 to 4 carbon atoms,
wherein a is 0, 1, 2 or 3,
wherein b is 0, 1, 2 or 3, and
wherein the sum total of a+b is ≤3 and in less than 50% of all units of formula (II) in the organopolysiloxane resin the sum total of a+b=2,
(Ad) optionally a further organopolysiloxane consisting of units of formula (III) and (IV) 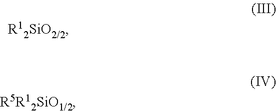
wherein R¹ has the definition as described above,
wherein R⁵ may be identical or different and may be R¹ or —OR⁶,
wherein R⁶ is a hydrogen atom or a monovalent, optionally substituted hydrocarbon radical having 1 to 25 carbon atoms,
(Ae) optionally water-insoluble organic compounds,
(Af) optionally an alkaline or acidic catalyst or the reaction product thereof with components (Aa) to (Ad);
(B) 10 to 45 parts by weight, based on 100 parts by weight of the defoamer formulation (A), of a waxy additive containing a monoester (B′) of glycerol and a fatty acid that is free of a polysiloxane-containing additive and that contains less than 5% by weight of a triester (B″) of glycerol and a fatty acid;
(C) 10 to 50 parts by weight, based on 100 parts by weight of the defoamer formulation (A), of a polycarboxylate binder that has a pH of 3 or less when it is dissolved in water; and
(D) 120 to 5000 parts by weight, based on 100 parts by weight of the defoamer formulation (A), of at least one pulverulent carrier material, with the proviso that the carrier material contains less than 50% by weight of alkaline carrier material, preferably less than 40% by weight of alkaline carrier material, more preferably less than 25% by weight of alkaline carrier material.

15. The defoamer of claim 14, wherein the polysiloxane (Aa) is an organopolysiloxane of the formula (VIII) 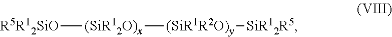
wherein R¹, R² and R⁵ have the definition given for them in claim 14,
wherein x is greater than or equal to 0 and on average less than 200, and
wherein y is on average greater than 5 and less than 200.

16. The defoamer of claim 14, wherein silicas are used as fillers (Ab).

17. The defoamer od claim 14, wherein the organopolysiloxane resins (Ac) used are MQ resins composed of units of the formulae 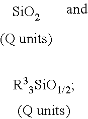
wherein the molar ratio of M to Q units is in the range from 0.5 to 2.0;
wherein the MQ resins may also contain, in addition to the M and Q units, small amounts of R³SiO_{3/2} or (R⁴O)SiO_{3/2} (T) units or R³₂SiO_{2/2} (D) units, in amounts from 0.01 to 20 mol %, based on the sum total of all siloxane units;
wherein the MQ resins may contain up to 10% by weight of free Si-bonded hydroxyl or alkoxy groups, such as methoxy or ethoxy groups; and
wherein R³ and R⁴ have the definition given for them in claim 14.

18. The defoamer of claim 14, wherein the waxy additive (B) contains greater than or equal to 30% by weight, preferably greater than or equal to 50% by weight and in particular greater than or equal to 70% by weight of a monoester of glycerol and a fatty acid and less than 5% by weight of a triacylglycerol in the total mixture of the waxy component (B) used.

19. The defoamer of claim 14, wherein the monoester of glycerol and a fatty acid is glycerol monolaurate, glycerol monomyristate, glycerol monopalmitate or glycerol monostearate.

20. The defoamer of claim 14, wherein the polycarboxylate binder (C) is a water-soluble or water-dispersible homopolymer, copolymer or a salt thereof comprising at least 60 percent by weight of segments of the general formula (V) 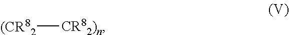
wherein n has a value between 10 and 100 000, preferably between 20 and 10 000, particularly preferably between 30 and 1000,
wherein R⁸ is selected from hydrogen, (optionally substituted) hydrocarbon radicals having 1 to 30 carbon atoms, carboxyl groups or salts thereof, and groups of the general formula 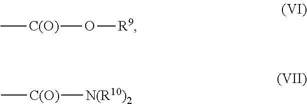
wherein R⁹ is an optionally functionalized hydrocarbon radical having 1 to 30 carbon atoms,
wherein R¹⁰ is either hydrogen, the radical R⁹ or R¹¹—SO₃X,
wherein R¹¹ is a divalent alkylene radical having 1 to 12 carbon atoms,
wherein X is a hydrogen atom or a cation, and
wherein at least 5 mol %, preferably at least 10 mol %, particularly at least 15 mol % of the radicals R⁸ are acidic groups selected from the carboxyl group or salts thereof and groups containing a sulfonyl group or salts thereof, preferably selected from the carboxyl group and salts thereof.

21. The defoamer of claim 14, wherein the polycarboxylate binder (C) is a homo- or copolymer of monomers selected from the group of acrylic acid, methacrylic acid, ethacrylic acid, maleic acid, itaconic acid, aconitic acid, mesaconic acid, 2-acrylamido-2-methylpropanesulfonic acid (AMPS), maleic anhydride and maleimide.

22. The defoamer of claim 14, wherein non-alkaline carrier materials such as phosphates, sodium sulfate, sodium bicarbonate, sodium citrate, sodium acetate or cellulose derivatives such as sodium carboxymethyl cellulose are used to an extent of greater than 50% by weight as pulverulent carrier materials.

23. The defoamer of claim 14, wherein the defoamer powders are used within a detergent or cleaning composition.

24. A process for producing defoamer powders, comprising:
a premix, preferably in the form of a dispersion, of defoamer formulation (A), waxy additive (B) and binder (C) is produced,
wherein (A) is 100 parts by weight of a defoamer formulation comprising
(Aa) a polysiloxane containing units of formula (I) 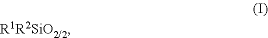
wherein R¹ may be identical or different and is a monovalent, optionally branched, SiC-bonded hydrocarbon radical having 1 to 5 carbon atoms, and
wherein R² may be identical or different and is a monovalent, optionally branched, SiC-bonded hydrocarbon radical having 6 to 30 carbon atoms,
(Ab) a filler,
(Ac) an organopolysiloxane resin composed of units of the general formula 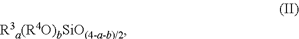
wherein R³ may be identical or different and is a monovalent, optionally substituted, SiC-bonded hydrocarbon radical having 1 to 30 carbon atoms,
wherein R⁴ may be identical or different and is a hydrogen atom or a monovalent, optionally substituted hydrocarbon radical having 1 to 4 carbon atoms,
wherein a is 0, 1, 2 or 3,
wherein b is 0, 1, 2 or 3, and
wherein the sum total of a+b is ≤3 and in less than 50% of all units of formula (II) in the organopolysiloxane resin the sum total of a+b=2,
(Ad) optionally a further organopolysiloxane consisting of units of formula (III) and (IV) 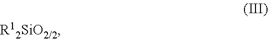
wherein R¹ has the definition as described above,
wherein R⁵ may be identical or different and may be R¹ or —OR⁶,
wherein R⁶ is a hydrogen atom or a monovalent, optionally substituted hydrocarbon radical having 1 to 25 carbon atoms,
(Ae) optionally water-insoluble organic compounds,
(Af) optionally an alkaline or acidic catalyst or the reaction product thereof with components (Aa) to (Ad),
wherein (B) is 10 to 45 parts by weight, based on 100 parts by weight of the defoamer formulation (A), of a waxy additive containing a monoester (B′) of glycerol and a fatty acid that is free of a polysiloxane-containing additive and that contains less than 5% by weight of a triester (B″) of glycerol and a fatty acid,
wherein (C) is 10 to 50 parts by weight, based on 100 parts by weight of the defoamer formulation (A), of a polycarboxylate binder that has a pH of 3 or less when it is dissolved in water, and
wherein (D) is 120 to 5000 parts by weight, based on 100 parts by weight of the defoamer formulation (A), of at least one pulverulent carrier material, with the proviso that the carrier material contains less than 50% by weight of alkaline carrier material, preferably less than 40% by weight of alkaline carrier material, more preferably less than 25% by weight of alkaline carrier material; and
mixing the premix with the pulverulent carrier material.

25. The process of claim 24, wherein the premix is mixed in the form of an aqueous dispersion with the pulverulent carrier material.

26. The process of claim 24, wherein the defoamer powder is subsequently dried.

27. The process of claim 24, wherein the defoamer powders are used within a detergent or cleaning composition.
